(19) United States
(12) Patent Application Publication
(10) Pub. No.: US 2012/0051321 A1
(43) Pub. Date: Mar. 1, 2012

(54) METHOD FOR SEAMLESS IP SESSION CONTINUITY FOR MULTI-MODE MOBILE STATIONS

(75) Inventors: Bhupal DE, Kirkland, WA (US); Srinivasa Rao MANTRALA, Redmond, WA (US)

(73) Assignee: CLEAR WIRELESS LLC, Kirkland, WA (US)

(21) Appl. No.: 12/907,751

(22) Filed: Oct. 19, 2010

Related U.S. Application Data
(60) Provisional application No. 61/376,593, filed on Aug. 24, 2010.

(51) Int. Cl. H04W 36/00

(52) U.S. Cl. 370/331

(57) ABSTRACT

A method and mobile station provides seamless IP session continuity between different RAN's (Radio Active Networks) that utilize different wireless access technologies. The mobile station includes internal software such that (1) when the mobile station is in a non-WiFi network, it establishes a mobile Internet protocol (MIP) tunnel between a home agent (HA) and the mobile station via a foreign agent (FA) of the network by either proxy mobile internet protocol (PMIP) with care of address (CoA) or client mobile internet protocol (CMIP) with CoA, and (2) when the mobile station detects that it is in a WiFi network, it establishes a MIP tunnel between the HA and the mobile station by either client mobile Internet protocol (PMIP) with co-located care of address (CCoA), or Internet protocol security (IPSec). In all cases, the HA conducts only a single IP address registration cycle during handoffs between different networks utilizing different technologies, whether they utilize 3G, WiMAX, or WiFi technology, thereby solving problems of handoff delay and increased overhead. Additionally, the use of an IPSec tunnel when the mobile station is in a WiFi network overcomes potential security vulnerabilities.

### RELATED APPLICATION

This application claims the priority of U.S. Provisional Application No. 61/376,593 filed Aug. 24, 2010, the entire document of which is expressly incorporated herein by reference.

### FIELD

This disclosure generally relates to wireless communication systems, and specifically concerns a method and mobile station for seamless session continuity between networks utilizing multiple wireless access technologies.

### BACKGROUND

Conventional wireless communication systems provide wireless connectivity using radio access networks or other wireless entities such as access points, base stations, base station routers, and the like. For example, a mobile station may establish a wireless communication link over an air interface with a radio access network that is a communicatively coupled to a network. The mobile station may use the wireless communication link to access services provided by the network such as establishing a communication session with another mobile station. The information transmitted using the communication session between the two mobile stations may be analog or digital information and the communication path between the mobile stations may be formed using a circuit-switched architecture or a packet-switched architecture. In a circuit-switched architecture, a dedicated communication path is formed between the two mobile stations and may only be used by the two mobile stations. In contrast, packet-switched architectures divide the information up into packets that can be transmitted along numerous paths between the two mobile stations using a common packet network infrastructure for forwarding the packets between the mobile stations and their network peers. Thus, some or all of the paths through a packet-switched network infrastructure may be shared by other mobile stations or other entities coupled to the packet-switched network such as a network server or a fixed subscriber.

Voice over Internet Protocol (VoIP) is a technique for encoding audio signals (such as voice signals) into a digital format that can be used to form packets for transmission over a packet-switched network. The VoIP packets are typically referred to as delay-intolerant information because large or variable delays between successive packets at the destination VoIP session peer (e.g., mobile station) may degrade the quality of the audio signal produced by the source peer. Consequently, VoIP applications are typically constrained to provide VoIP packets at a selected quality-of-service (QoS) level. For example, a VoIP application implemented in a mobile station may be required to maintain minimum levels of delay for packets transmitted over the network. In some cases, customers may pay larger fees to obtain overall higher QoS levels for certain applications.

Numerous wireless access technologies may be used to support packet data applications. Some exemplary wireless access technologies include WiFi, third generation (3G) technologies such as EvDO, and fourth generation (4G) technologies such as LTE and WiMAX. To take advantage of the different signal strengths and existing coverage areas of these already-deployed technologies, equipment vendors are developing and deploying dual mode (or multi-mode) mobile stations that are capable of communicating using multiple wireless access technologies. For example, a dual-mode mobile station may implement two independent means of IP connectivity that operate according to two different wireless access technologies. At the same time, some service providers have deployed heterogeneous networks that include overlaid meshes and/or overlapping coverage areas with different access technologies.

Individual mobile stations may frequently handoff between radio access networks that utilize different wireless access technologies (and operate based upon the corresponding technology standards), as the multi-mode mobile station roams across a heterogeneous network. For example, as schematically illustrated in FIG. 1, a mobile station may initially enter such a heterogeneous network via a WiMAX radio access network. using the IEEE 802.16e standard over the air and WiMAX forum NWG standard for establishing a mobile Internet protocol (MIP) v4 session. The mobile station may then determine that the signal quality of the WiMAX wireless communication link has degraded and may elect to handoff to a EvDO radio access network using an EvDO wireless communication link over an EvDO Radio access network, with an MIPv4 session established based upon 3GPP2 standards for a VoIP call. Finally, the mobile station may then determine that the signal quality of the EvDO wireless communication link has degraded and may then elect to handoff to a WiFi access point via a wireless access router with 802.11a/b/g technology.

Regardless of where a mobile station roams, it must continue to communicate with its home agent (HA) to maintain a permanent home address stored in the system of the HA.

### SUMMARY

While there presently exist mobile internet protocol models (MIPs) capable of implementing handoffs between RANs utilizing different technologies and allowing the mobile station to continue to communicate with its HA, the applicants have observed that such models are accompanied by a number of shortcomings. In particular, such models generally necessitate two IP address registration cycles every time the mobile station is handed off between WiMAX and 3G networks. This substantially increases the time necessary for handoff since two different IP addresses are being requested before the mobile station can perform the data session continuity function. The resulting delay renders such a model unusable for mobile VoIP handovers, and increases the amount of IP overhead incurred. This is of particular concern with respect to 3G networks whose throughput is far less than that of WiFi or WiMAX. This problem will worsen for the service providers as the subscriber count grows and the HA has to allocate more and more resources for management of the CoAs and CCoAs assigned to each mobile station. Finally, in the case where the mobile station communicates with its HA in a WiFi environment, the user identity and data in the WiFi domain may be unprotected, and the direct interaction between the mobile station and the HA leaves the HA vulnerable for DDOS attacks.

The method and mobile station of the invention overcomes the aforementioned shortcomings. The mobile device associated with the mobile station includes internal software in its operating system such that (1) when the mobile station is in a non-WiFi network, it establishes a mobile internet protocol (MIP) tunnel between a home agent (HA) and the mobile station via a foreign agent (FA) of the network by either proxy mobile internet protocol (PMIP) with care of address (CoA) or client mobile internet protocol (CMIP) with CoA, and (2) when the mobile station detects that it is in a WiFi network, it establishes a MIP tunnel between the HA and the mobile station by either client mobile internet protocol (PMIP) with co-located care of address (CCoA), or internet protocol security (IPSec).

The method and mobile station of the invention obviate the need for two IP address registration cycles every time the mobile station is handed off between networks utilizing 3G, WiMAX or WiFi technology, thereby solving the aforementioned problems of delay and overhead. Insofar as second IP addresses are needed to establish a MIP tunnel between the mobile station and the HA, such second addresses are always provided by the network via dynamic host configuration protocol (DHCP) in the case of WiMAX and WiFi, and via CoA in 3G networks where the second address is merely the address of the FA. The invention further overcomes the aforementioned security vulnerabilities when transitioning to a WiFi environment by requesting an IPSec with CoA tunnel with the packet data interface function (PDIF) element of the WiFi network.

These and other advantages, features and attributes of the disclosed methods and devices and their advantageous applications and/or uses will be apparent from the detailed description that follows, particularly when read in conjunction with the figures appended hereto.

### BRIEF DESCRIPTION OF THE DRAWINGS

The disclosure is further explained in the description that follows with reference to the drawings illustrating, by way of non-limiting examples, various embodiments wherein:

FIG. 1 is a schematic diagram generally illustrating how session continuity is achieved between networks employing WiMAX, EvDO and WiFi technology;

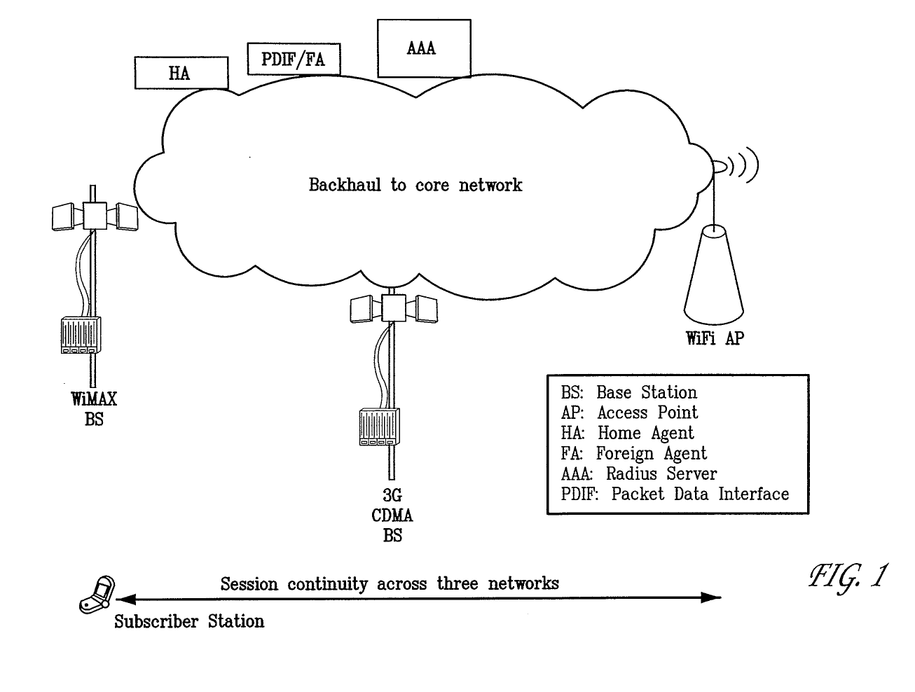

FIG. 2 illustrates the prior art network architecture for network continuity;

FIG. 3A is a schematic diagram illustrating the system of the invention;

FIG. 3B is a flow chart of the method of the invention;

FIG. 4 illustrates the network continuity architecture implemented by a first embodiment of the method of the invention, and

FIG. 5 illustrates the network continuity architecture implemented by a second embodiment of the method of the invention.

### DETAILED DESCRIPTION OF THE EMBODIMENTS

Various aspects will now be described with reference to specific embodiments selected for purposes of illustration. It will be appreciated that the spirit and scope of the methods and devices disclosed herein are not limited to the selected embodiments. Moreover, it is to be noted that the figures provided herein are not drawn to any particular proportion or scale, and that many variations can be made to the illustrated embodiments.

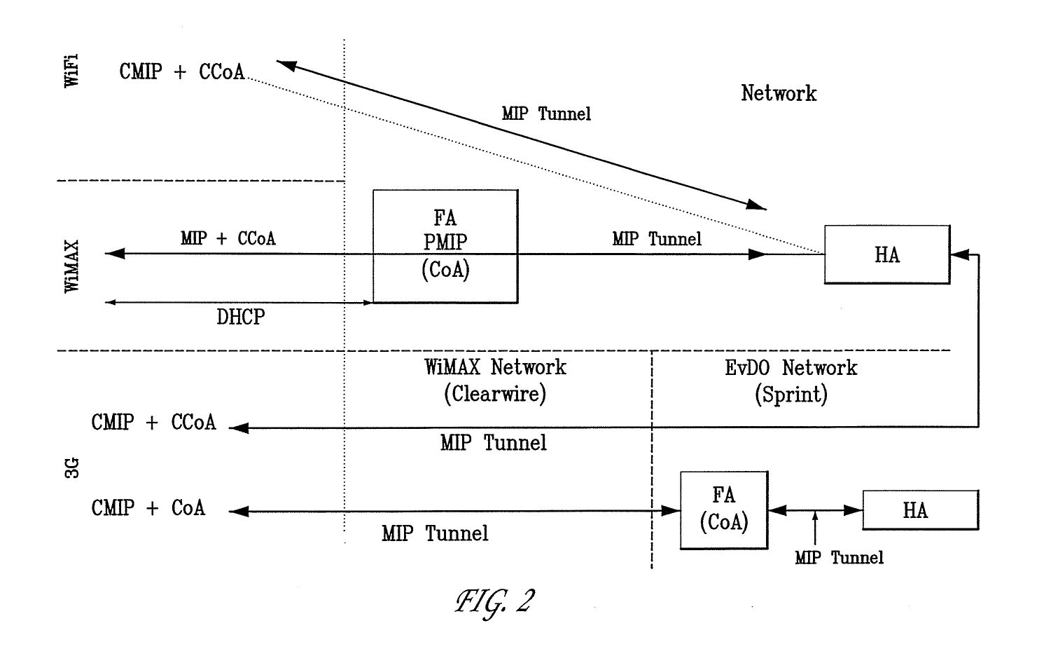

FIG. 2 schematically illustrates the existing mobile internet protocol model (MIPs) that allows continued communication between the mobile station and the HA as the mobile station is handed off between different access networks utilizing different wireless technologies. However, before FIG. 2 is discussed in detail, the following definitions are in order:

Mobile Station (MS): This is a mobile handset which uses radio (wireless) to connect to a network infrastructure incorporating three different radio technologies, namely WiFi, WiMAX and 3G (such as EvDO). It is sometimes referred to as a mobile node.
Access Point (AP): A wireless access router with 802.11a/b/g technology that connects to the internet cloud on the back end. The mobile station gains access to the network through this element in a WiFi environment.
Datagram: A unit of information in the Internet Protocol (IP) containing both data and address information. In TCP/IP networks, datagrams are referred to as packets.
Home Agent (HA): A router on a mobile station's home network which tunnels datagrams for delivery to the mobile station when it is away from home, and maintains current location information for the mobile station. The HA interacts with an authentication, authorization and accounting (AAA) server for subscriber management and IP address allocation for the mobile station.
Foreign Agent (FA): A router on a mobile station's visited network which provides routing services to the mobile station while registered. The foreign agent de-tunnels and delivers datagrams to the mobile station that were tunneled by the mobile station's home agent. For datagrams sent by a mobile station, the foreign agent may serve as a default router for registered mobile stations.
Packet Data Interface Function (PDIF): A core IP network element which has secure gateway functionality towards the subscriber side and foreign agent functionality facing the HA.
Dynamic Host Configuration Protocol (DHCP): A computer networking protocol used by hosts (DHCP clients) to retrieve IP address assignments and other configuration information.
Access Service Node (ASN): A network element in WiMAX environment for the subscriber to gain access to the network for the services requested.
Radio Area Network (RAN): Each network is assumed to be made up of one standard radio solution for connectivity to the network from the subscriber's perspective. In this application the wireless technologies in play are 802.16e, 802.11 and 3G.

FIG. 2 illustrates that two types of MIP tunnels are presently used to transfer datagrams between the mobile station and the HA as the mobile station moves between different RANs utilizing one of 3G, 4G (such as WiMAX) or WiFi, including (1) client-mobile IP with care of address (CMIP with CoA) and (2) client-mobile IP with co-located care of address (CMIP with CCoA). Each of these will now be discussed in detail.

When mobile station senses that it has entered a foreign network utilizing 3G technology (such as EvDO), it launches a MIP registration request. The visited network, acting as FA, relays the MIP registration request to the HA. The HA in turn checks the credentials of the mobile station with the AAA database, assigns an IP address on the home network, and binds this IP address with that of the FA that initiated the registration request. A MIP tunnel is established between the HA and the FA by encapsulating the datagrams with a new IP header using the care-of address (CoA) assigned by the FA. This type of tunnel is known as client-mobile IP with care of address (CMIP with CoA).

When mobile station senses that it has entered a foreign network utilizing WiMAX technology, it launches a request for an address and the WiMAX base station access service network-gateway (BS/ASN GW) issues a dynamic host configuration protocol (DHCP) address to the mobile station. The mobile station further sends in a MIP registration request to the HA. Once the HA checks the credentials of the mobile station with the AAA server, the HA assigns it an IP address on the home network and binds it to the address the mobile station acquired via DHCP. A MIP tunnel is established between the HA and the mobile station by encapsulating datagrams with a new header using the IP address acquired via DHCP; this address being referred to as a co-located care of address which then becomes the CCoA for the mobile station. The difference between care of address (CoA) and the co-located care of address (CCoA) is that the care of address is internal to the mobile device in the case of CCoA. This type of tunnel is known as client-mobile IP with co-located care of address (CMIP with CCoA).

When the mobile station senses that it has entered a WiFi environment, it requests a local IP address via the WiFi access point (AP). After the mobile station acquires a local IP address it launches a MIP registration request which is relayed to the HA. The HA verifies the credentials with the AAA database and responds by assigning an IP address to the mobile station. Since the mobile unit internally possesses the destination address assigned to the station by the WiFi AP to which HA routes the packets destined for the mobile station, this type of tunnel is another form of CMIP with CCoA.

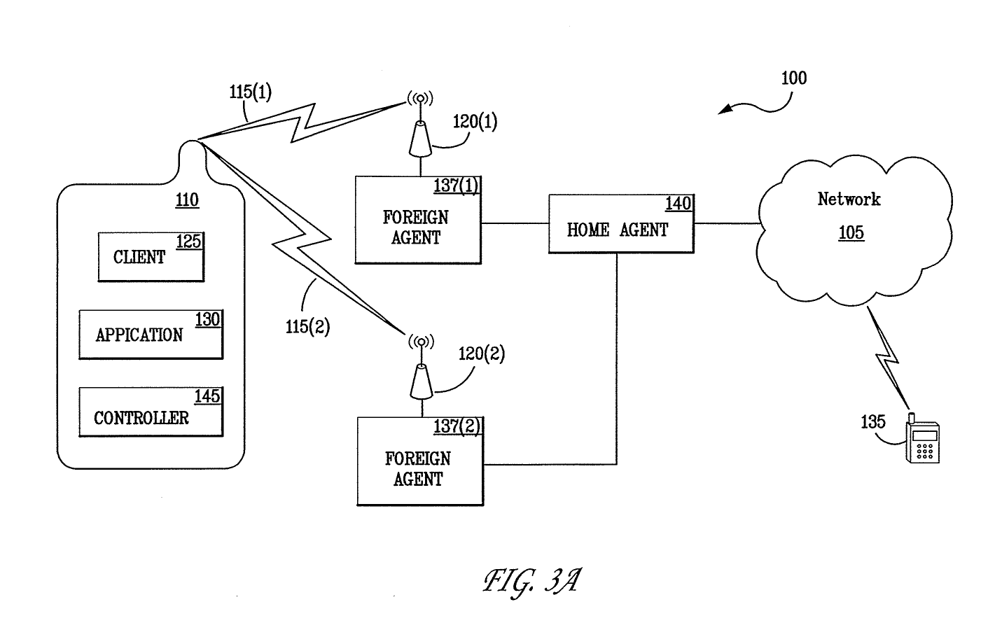

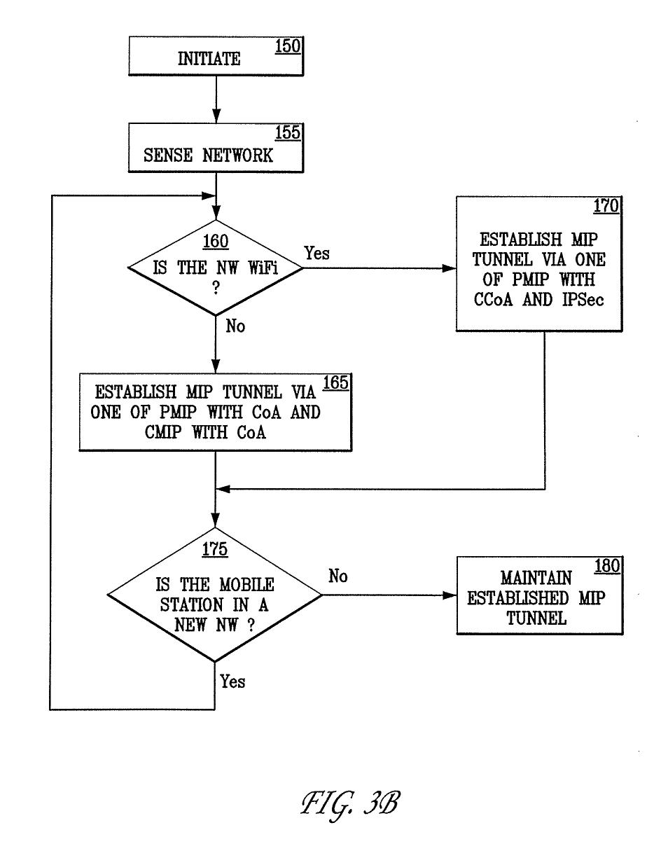

FIG. 3A illustrates the interaction between the mobile station of the invention and a wireless communication system 100. The system 100 includes a network 105 that may be used to support packet-switched communication based upon Mobile Internet Protocol (MIP) and IP. Portions of the network 105 may operate according to various standards and/or protocols including WiFi based on IEEE 802.11 standards, the standards and/or protocols defined by the Third Generation Partnership Project (3GPP. 3GPP2) such as Universal Mobile Telecommunication Services (UMTS) and Evolved Data-Optimized (EvDO), while still other portions may operate according to later generation protocols such as WIMAX and LTE. However, persons of ordinary skill in the art having benefit of the present disclosure should appreciate that the present invention is not limited to these exemplary standards and/or protocols. In alternative embodiments, portions of the wireless communication system 100 and/or the network 105 may operate according to any standards and/or protocols.

The system 100 includes the mobile station 110 of the invention which is located within a mobile device as shown. The mobile station 110 may establish wireless communication with the network 105, and is preferably a multi-mode device that may form wireless communication links according to all of the aforementioned wireless access technologies.

In operation, the mobile station 110 may form a wireless communication link 115(1) with a radio access network 120(1) that operates according to a first wireless access technology, such as EvDO. In the illustrated embodiment, the mobile station 110 may instantiate a client 125 at the network layer according to the first wireless access technology. As used herein, the term “layer” refers to different levels of a hierarchical architecture that is defined for network communication. A layer is a collection of related functions that provides services to the layer above it and receives service from the layer below it. One exemplary layer definition is the Open Systems Interconnection (OSI) Basic Reference Model that defines (from top to bottom) the Application, Presentation, Session, Transport, Network, Data Link, and Physical layers. An application 130 in the mobile unit 110, such as a VoIP application, may use the client 125 for communication over the wireless communication link 115(1). For example, the mobile station 110 may establish a MIP session over the wireless communication link 115(1) and use this MIP session to establish a call with a different mobile station 135 from the radio access point (AP) 120(1) via a foreign agent (FA) 137(1), a home agent (HA) 140, and the network 105.

A controller 145 in the mobile station 110 may monitor channel conditions associated with the wireless communication link 115(1). If the controller 145 determines that the channel conditions of the wireless communication link 115(1) have degraded, the controller 145 may initiate a handover to a different wireless access technology. The controller 145 may compare a parameter such as a pilot signal strength, a signal-to-noise ratio, a signal-to-noise-plus-interference ratio, a bit error rate, and the like to an appropriate threshold to determine when the channel conditions have degraded to the point that a handover to a different wireless access technology is desirable and/or necessary. The handoff may also be triggered based on preconfigured application-based policy preferences. For example, a handover from WiMAX to EvDO may be triggered as soon as the target technology signal strength is greater than certain threshold, irrespective of the source technology signal strength. Furthermore, the handoff may be triggered based on preconfigured user preferences. For example, if WiMAX access is cheaper the controller 145 may elect to switch to WiMAX as soon as its signal strength is adequate. In some cases, the service provider network policy may override the user policy. When the controller 145 decides to initiate a handover, the controller 145 causes the client 125 in the mobile unit 110 to establish a second wireless communication link 115(2) according to the second wireless access technology.

In the system 100, the controller 145 within the mobile station 110 contains software that instructs the various components of the network how to establish both the initial link 115(1) and the handover communication link 115(2). This software is generally illustrated in the flow chart of FIG. 3B, which also illustrates the method of the invention.

If the answer to inquiry step 160 is “yes” (i.e., the technology of the sensed network is WiFi), then the software proceeds to step 165 and issues instructions to the network components that establish a MIP tunnel based on one of (1) proxy MIP with co-located care of address (CCoA) or (2) IP secured (IPSec). If the answer is “no” (i.e., the technology of the sensed network is something other than WiFi) then the software proceeds to step 170 and inquires whether the sensed network is based on 3G technology such as EvDO. If the answer is “yes”, then the software proceeds to step 175 and issues instructions to the network components that establish a MIP tunnel via CMIP with care of address (CoA). If the answer is “no” then the software proceeds to step 180 and inquires whether the based on a 4G technology such as WiMAX or LTE. If the answer to the inquiry is “yes”, then the internal software of the mobile station proceeds to step 185 and establishes a MIP tunnel via proxy mobile internet protocol (PMIP) with care of address (CoA).

After a MIP tunnel is established either via step 165, 175 or 185, the software proceeds to step 190 and inquires whether mobile station is in a new network. If the answer is “no”, then the established MIP tunnel is maintained, as indicated in step 195. However, if the answer to inquiry step 190 is “yes”, and the controller 145 further decides that a handover is desirable (in accordance with the previously discussed criteria) then the software contained in controller 145 returns to inquiry step 160, and re-establishes a MIP tunnel in accordance with either step 165, 175 or 185.

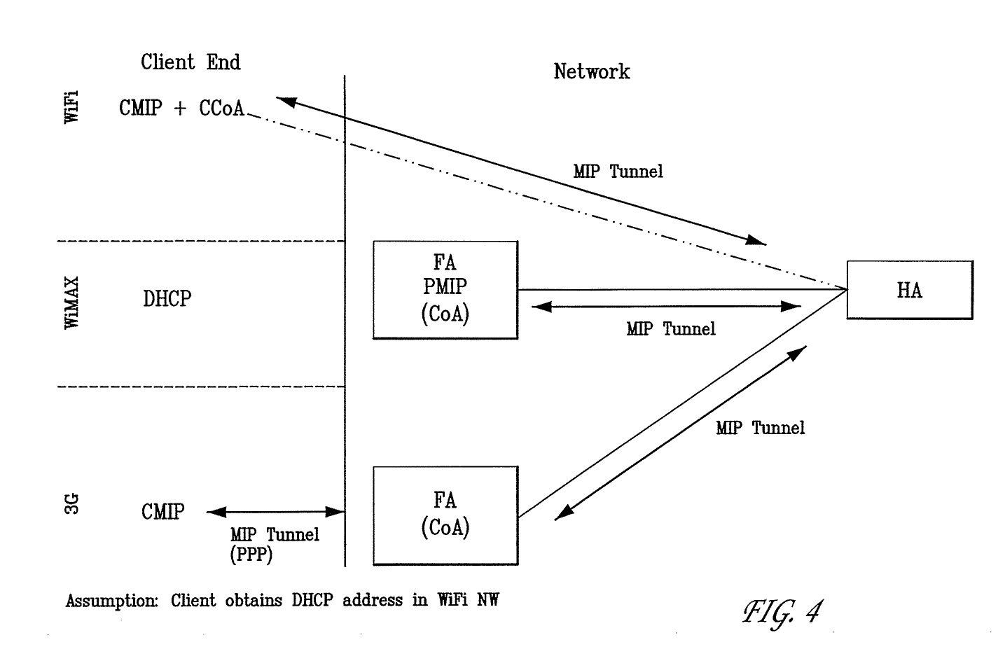

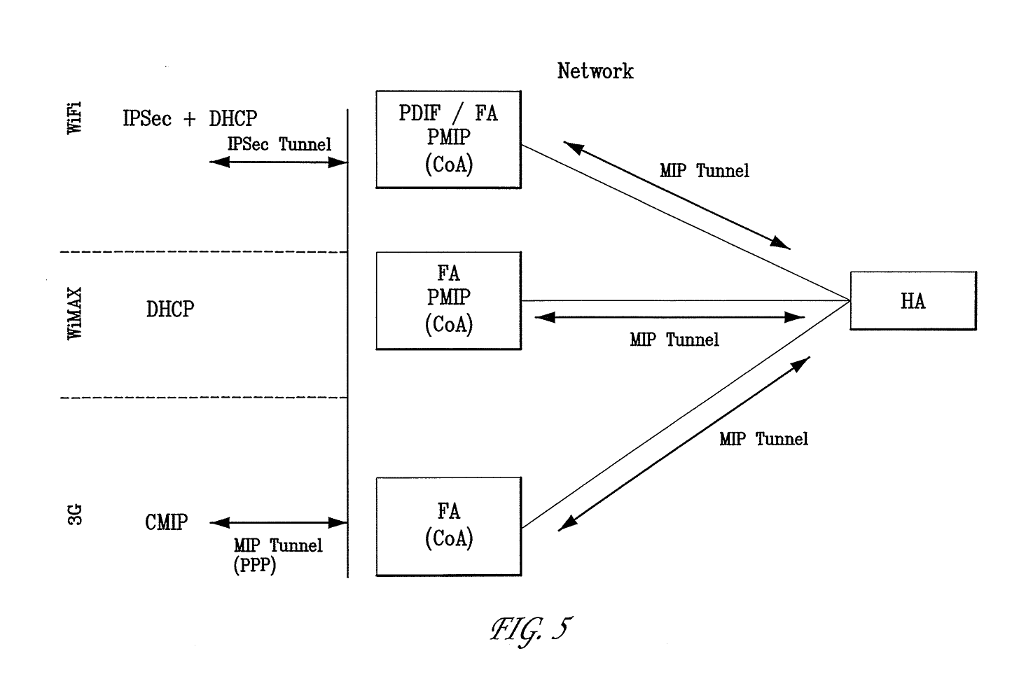

Implementation of the software outlined in FIG. 3 results in either the network model illustrated in FIG. 4 or the network model illustrated in FIG. 5, depending on what type of MIP tunnel is established when the controller 145 senses that it is in a WiFi network. Specifically, when proxy MIP with co-located care of address (CCoA) is used to establish a MIP tunnel between a WiFi network and the mobile station 110, the FIG. 4 network model is implemented. When IPSec is used instead to establish the MIP tunnel with the WiFi network, the FIG. 5 network model is implemented. As indicated previously, the use of IPSec in the FIG. 5 model overcomes security vulnerabilities that would otherwise be present if proxy MIP with co-located care of address (CCoA) is used. A description of the behavior of the mobile station 110 for options 1 and 2 is given below:

Mobile Station Behavior in Option-1

### WiFi Network:

MS registers with the Access Point (AP)>
The mobile IP (MIP) client initiates a MIP registration request when data session is initiated
The HA checks with the database (DB) for credentials and responds the MIP request
MIP tunnel established between MS & HA

### WiMAX Network:

MS registers with the network
Obtains DHCP address from the NW
MIP registration request sent from Base Station (BS) to FA
The foreign agent (FA) checks with AAA and responds
The foreign agent (FA) then forwards the MIP registration request to home agent (HA)
HA checks with AAA and responds back
Tunnel established between the FA and the HA

### 3G Network:

MS registers with the network
The mobile IP (MIP) client initiates a MIP registration request when data session is initiated
The foreign agent (FA) checks with AAA and responds
The foreign agent (FA) then forwards the MIP registration request to home agent (HA)
HA checks with AAA and responds back
   Tunnel established between the MS and the HA
   In Option 1, the advantage of implementing CMIP with CoA in the 3G domain is that it requires only one IP address and in addition has the advantage of reduced overhead. However the security in the WiFi domain is still a concern, unless the user identity and data in this domain is secured. No such security concerns are present in the 3G and WiMAX domains as these networks are usually secured by the service providers.

Mobile Station Behavior in Option-2

### WiFi Network:

MS registers with the AP.
Established an IPSec tunnel between the MS and Packet Data Interface Function (PDIF/FA) network element.
PDIF acts as a proxy and initiates a MIP registration request to HA.
HA checks with AAA and responds.
PDIF/FA now is the Care of Address(CoA) for the MS.

### 3G Network:

MS registers with the network.
The mobile IP (MIP) client initiates a MIP registration request when data session is initiated.
The foreign agent (FA) checks with AAA and responds.
The foreign agent (FA) then forwards the MIP registration request to home agent (HA)
HA checks with AAA and responds back.
Tunnel established between the MS and the HA.

### WiMAX Network:

MS registers with the network.
Obtains DHCP address from the NW.
MIP registration request sent from Base Station (BS) to FA.
The foreign agent (FA) checks with AAA and responds.
The foreign agent (FA) then forwards the MIP registration request to home agent (HA).
HA checks with AAA and responds back.
Tunnel established between the FA and the HA.

In Option 2 security of the user is insured in the WiFi domain. This is achieved as follows. When the mobile station 110 moves across to a WiFi domain from either WiMAX or 3G, the mobile station 110 establishes an IPSec tunnel between the client 125 and the Packet Data Interface (PDIF) node of the WiFi network. The PDIF node is a new network element of WiFi networks which is capable of terminating the IPSec tunnel and is embedded with FA functionality. This way the link from the mobile station is secured. Now the client 125 launches DHCP request and the PDIF handles the PMIP registration from the client and establishes a MIP tunnel between the PDIF and the HA. The end result is a MIP tunnel inside an IPSec tunnel.

To summarize, when the mobile station 110 detects a 3G network, it establishes a Mobile IP MIP tunnel between the Foreign Agent and the Home Agent with FA acting as the Care Of Address (CoA) for the mobile station, which is assigned an IP address by the Home Agent. When the mobile station 110 detects another radio (i.e. WiMAX), it will make a network entry and request an IP address in which the FA will proxy the same to the HA. The HA being the anchor point, and being aware of the mobile station 110, it will in turn serve the mobile station with the same IP address. When the mobile station 110 in a third instance detects a WiFi network, in Option 1 it will enter the network and initiate a Mobile IP registration request to the HA directly. The HA which again is the anchor point, and being aware of the mobile station 110, will provide the same IP address and refer this to as Co-located Care Of Address (CCoA). In Option 2, it will enter the network and establish an IPSec tunnel between the mobile station 110 and the packet data interface function (PDIF) element in the network. This PDIF element also comprises an FA component which initiates a MIP registration request to the HA. The HA again is the anchor point, and being aware of the mobile station 110, will provide the same IP address.

All patents, test procedures, and other documents cited herein, including priority documents, are fully incorporated by reference to the extent such disclosure is not inconsistent and for all jurisdictions in which such incorporation is permitted

While the illustrative embodiments disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside herein, including all features which would be treated as equivalents thereof by those skilled in the art to which this disclosure pertains.

We claim:

1. A seamless IP session continuity method for a mobile station associated with a mobile device that is capable of communicating with different RAN's (Radio Active Networks) that utilize different wireless access technologies, the method being implemented by software incorporated within the mobile device, comprising:
when the mobile station detects that it is in a network utilizing a wireless access technology other than WiFi, establishing a mobile internet protocol (MIP) tunnel between a home agent (HA) and the mobile station via a foreign agent (FA) of the network by one of the group consisting of proxy mobile internet protocol (PMIP) with care of address (CoA) and client mobile internet protocol (CMIP) with CoA, and
when the mobile station detects that it is in a network utilizing WiFi wireless access technology, establishing a MIP tunnel between the HA and the mobile station by one of the group consisting of client mobile internet protocol (PMIP) with co-located care of address (CCoA), and internet protocol security (IPSec),
wherein the HA conducts only a single IP address registration cycle during handoffs between different networks utilizing different technologies.

2. The method of claim 1, wherein the network utilizing the non-WiFi technology is one of a 3G, WiMAX and LTE technology.

3. The method of claim 2, wherein when the mobile station detects that it is in a network utilizing 3G wireless access technology, establishing a mobile internet protocol MIP tunnel between the HA and the mobile station via CMIP with CoA.

4. The method of claim 2, wherein when the mobile station detects that it is in a network utilizing WiMAX wireless access technology, establishing a mobile Internet protocol MIP tunnel between the HA and the mobile station via PMIP with CoA.

5. The method of claim 1, wherein when the mobile station detects that it is in a network utilizing WiFi wireless access technology and establishes a MIP tunnel via IPSec, an IPSec with dynamic host configuration protocol (DHCP) tunnel is established between the mobile station and a packet data interface (PDIF) element in the WiFi network.

6. The method of claim 5, wherein after the IPSec tunnel is established a MIP tunnel is established between the PDIF and the HA.

7. The method of claim 4, wherein when the mobile station detects that it is in a network utilizing WiMAX wireless access technology, the mobile station receives a dynamic host configuration protocol (DHCP) address from a base station of the WiMAX network as a result of a registration request to the WiMAX network.

8. The method of claim 1, wherein when the mobile station detects that it is in a WiFi network, the mobile station receives a dynamic host configuration protocol (DHCP) address as a result of registration request to the WiFi network.

9. The method of claim 2, wherein the 3G network utilizes EvDO technology.

10. A seamless IP session continuity method implemented by software internal to a mobile device associated with a mobile station that is capable of communicating with different RAN's (Radio Active Networks) that utilize different wireless access technologies, comprising:
when the mobile station detects that it is in a network utilizing a wireless access technology other than WiFi, establishing a mobile internet protocol (MIP) tunnel between a home agent (HA) and the mobile station via a foreign agent (FA) of the network by one of the group consisting of proxy mobile internet protocol (PMIP) with care of address (CoA) and client mobile internet protocol (CMIP) with CoA, and
when the mobile station detects that it is in a network utilizing WiFi wireless access technology, establishing an internet protocol security (IPSec) tunnel between the HA and the mobile station,
wherein the HA conducts only a single IP address registration cycle during handoffs between different networks utilizing different technologies.

11. The method of claim 10, wherein the network utilizing the non-WiFi technology is one of a 3G, WiMAX and LTE technology.

12. The method of claim 11, wherein when the mobile station detects that it is in a network utilizing 3G wireless access technology, establishing a mobile Internet protocol MIP tunnel between an HA and the mobile station via CMIP with CoA.

13. The method of claim 11, wherein when the mobile station detects that it is in a network utilizing WiMAX wireless access technology, establishing a mobile internet protocol MIP tunnel between an HA and the mobile station via PMIP with CoA.

14. The method of claim 10, wherein when the mobile station detects that it is in a network utilizing WiFi wireless access technology and establishes a MIP tunnel via IPSec, an IPSec with dynamic host configuration protocol (DHCP) tunnel is established between the mobile station and a packet data interface (PDIF) element in the WiFi network.

15. The method of claim 11, wherein the 3G technology is EvDO.

16. A mobile station associated with a mobile device that is capable of communicating with different RAN's (Radio Active Networks) that utilize different wireless access technologies, comprising:
a computer readable memory component located within the mobile device that incorporates network interaction program instructions such that
when the mobile station detects that it is in a network utilizing a wireless access technology other than WiFi, establishing a mobile internet protocol (MIP) tunnel between a home agent (HA) and the mobile station via a foreign agent (FA) of the network by one of the group consisting of proxy mobile internet protocol (PMIP) with care of address (CoA) and client mobile internet protocol (CMIP) with CoA, and
when the mobile station detects that it is in a network utilizing WiFi wireless access technology, establishing a MIP tunnel between the HA and the mobile station by one of the group consisting of client mobile Internet protocol (PMIP) with co-located care of address (CCoA), and Internet protocol security (IPSec),
wherein the HA conducts only a single IP address registration cycle during handoffs between different networks utilizing different technologies.

17. The mobile station of claim 16, wherein the network utilizing the non-WiFi technology is one of a 3G, WiMAX and LTE technology.

18. The mobile station of claim 17, wherein when the mobile station detects that it is in a network utilizing 3G wireless access technology, establishing a mobile Internet protocol MIP tunnel between an HA and the mobile station via CMIP with CoA.

19. The mobile station of claim 17, wherein when the mobile station detects that it is in a network utilizing WiMAX wireless access technology, establishing a mobile internet protocol MIP tunnel between an HA and the mobile station via PMIP with CoA.

20. The mobile station of claim 16, wherein when the mobile station detects that it is in a network utilizing WiFi wireless access technology and establishes a MIP tunnel via IPSec, an IPSec with dynamic host configuration protocol (DHCP) tunnel is established between the mobile station and a packet data interface (PDIF) element in the WiFi network.
